(19) United States
(12) Patent Application Publication
(10) Pub. No.: US 2008/0068485 A1
(43) Pub. Date: Mar. 20, 2008

(54) Image pickup device having quickview display function

(75) Inventor: Masami Yuyama, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 11/901,670

(22) Filed: Sep. 18, 2007

(30) Foreign Application Priority Data
Sep. 20, 2006 (JP) 2006-253633

(51) Int. Cl. H04N 5/225

(52) U.S. Cl. 348/333.01; 348/E05.024

(57) ABSTRACT

In quickview display processing, a counter N is set to an initial value of 1, and a counter L is set to 4 times the counter N. Then, from a storage memory, the Lth frame of image data in frame data recorded by high-speed consecutive photographing is extracted, and an image based on this extracted image data is displayed by a display device. Consequently, by iteratively executing the processing according to this flowchart, the fourth, eighth, twelfth, etc., frames of image data are read from the frame data, and as a result of the displaying of the extracted image and passage of a redetermined time, images based on these read image data, being every fourth frame of the frame data, are displayed at a predetermined time interval by the display device.

### BACKGROUND OF THE INVENTION

1. Field of the Invention

The present invention relates to image pickup devices and image display control methods, implementable in digital cameras, provided with a function for displaying a photographed image immediately after the photographing thereof (to be referred to hereinafter as “quickview display”).

2. Description of the Related Art

Image pickup devices having quickview display functions are conventionally known. These image pickup devices activate the quickview display immediately after a consecutive photographing, and thereby display a plurality of images acquired by the consecutive photographing either in succession, or alternatively on a multi-screen display. Consequently, as a result of the user viewing the quickview display, the user is able to confirm the photographed contents of the consecutive photographing, and is able to subsequently conduct the next shoot (for example, refer to Japanese Unexamined Patent Application KOKAI Publication Nos. 2001-230958 and 2000-50140.)

However, when successively displaying the plurality of images acquired by the consecutive photographing as described above, the time required for the quickview display becomes longer as the number of consecutively photographed images increases (for example, 30 images). This behavior can cause the user to lose the next photographic opportunity and hinder a photographic shoot. Needless to say, if a photographic opportunity arises, it is possible to avoid any hindrance to the next shot by canceling the quickview display. However, by canceling this display the user can only partially confirm the contents of the last shot, and is thus forced to take the next shot while being unsure about the last shot.

On the other hand, for quickview displays wherein the plurality of images acquired by consecutive photographing are displayed on a multi-screen display, it is possible to shorten the time required for display. However, given that the display screen provided on the image pickup device has a limitation in size, as the number of consecutive images increases, the display size of each image displayed in the multi-screen becomes relatively smaller, thus making it difficult to confirm the contents of the shot.

The objective of the present invention, being devised to solve the problems of the above-described conventional art, is to provide an image pickup device and image display control method wherein, even in the cases where the number of consecutively photographed images is large or the video length is long, the quickview display time wherein these photographed images are displayed immediately after shooting is shortened, and furthermore, confirming the contents of the shot is simplified.

### SUMMARY OF THE INVENTION

In a first aspect of the present invention, an image pickup device comprises the following: a display unit; an acquisition unit for acquiring a plurality of the consecutive object images by consecutively photographing the object according to the predetermined frame rate in response to the photographic operations; a recording unit for recording the plurality of the object images acquired by this acquisition unit; an image number reducing unit for reducing the plurality of the object images of the number acquired by the acquisition unit; immediately after the plurality of object images are acquired by the acquisition unit, a display control unit for causing the display unit to display the number of the plurality of the object images reduced in the image number reducing unit.

In another aspect of the present invention an image display control method is provided, which comprises the steps of: an acquisition step for acquiring a consecutive plurality of object images by consecutively photographing an object according to a predetermined frame rate in response to photographic operations; a recording step for recording the plurality of object images acquired in the acquisition step; an image number reducing step for reducing the plurality of object images of the number acquired in the acquisition step; and, immediately after acquiring the plurality of object images in the acquisition step, a display step for displaying the plurality of object images, the number thereof having been reduced in the image number reduction step.

In another aspect of the present invention there is provided an image display control program (recorded on a recording medium) for causing a computer to perform certain functions, the computer contained in an image pickup device comprising: a display unit; an acquisition unit for acquiring a consecutive plurality of object images by consecutively photographing an object according to a predetermined frame rate in response to photographic operations; and a recording unit for recording the plurality of object images acquired by the acquisition unit. Wherein, the program causes the computer to function as: an image number reducing unit for reducing the plurality of object images of the number acquired by the acquisition unit; and a display control unit for causing the display unit to display the plurality of object images, the number thereof having been reduced in the image number reducing unit, immediately after the plurality of object images are acquired by the acquisition unit.

### BRIEF DESCRIPTION OF THE DRAWINGS

These objects and other objects and advantages of the present invention will become more apparent upon reading of the following detailed description and the accompanying drawings in which:

FIG. 1 is a block diagram of a digital camera in accordance with one embodiment of the present invention;

FIG. 2 is a flowchart showing the procedure of the consecutive photographing mode processing common to each embodiment of the present invention;

FIG. 3 is a flowchart showing the procedure of the quickview display processing in the first embodiment of the present invention;

FIG. 4 is an explanatory diagram showing the operation of the first embodiment;

FIG. 5 is a flowchart showing the procedure of the quickview display processing in the second embodiment of the present invention;

FIG. 6 is a flowchart showing the procedure of the quickview display processing in the third embodiment of the present invention;

FIG. 7 is an explanatory diagram showing the operation of the third embodiment; and

FIG. 8 is a flowchart showing the procedure of the quickview display processing in the fourth embodiment of the present invention.

### DETAILED DESCRIPTION OF THE PREFERRED EMBODIMENTS

Hereinafter, one embodiment of the present invention will now be described with reference to the accompanying drawings.

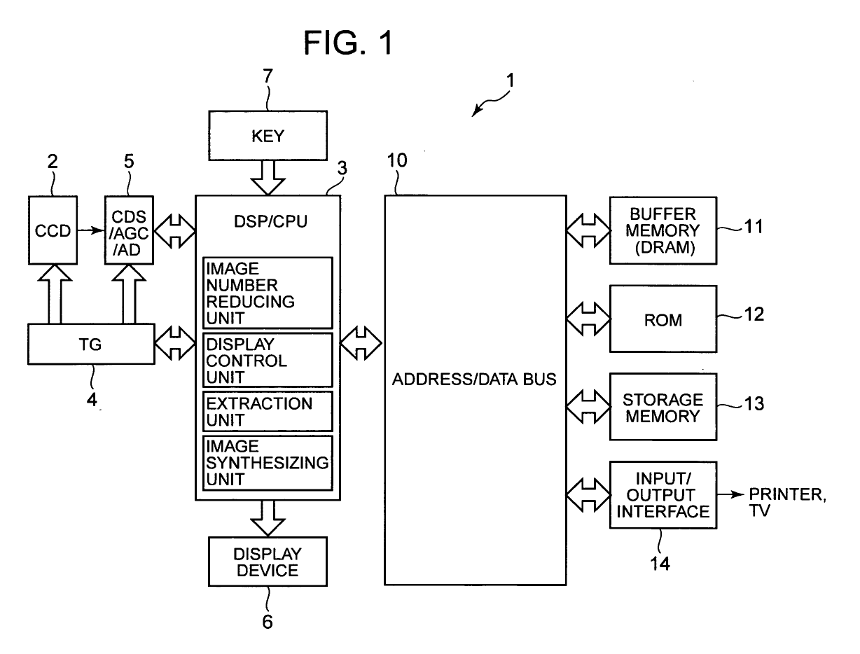

FIG. 1 is a block diagram showing the configuration of a circuit for a digital camera 1, which is common to each embodiment of the present invention. This digital camera 1 is provided with still picture photographing functions and consecutive photographing (moving picture photographing) functions, furthermore the consecutive photographing has an ordinary consecutive photographing function, wherein shooting is conducted at a frame rate of 60 fps, and a high-speed consecutive photographing function, wherein shooting is conducted at a frame rate of 240 fps. This digital camera 1 is also provided with a CCD 2 (acquisition unit) and a DSP/CPU 3, the CCD 2 is provided with primary color filters of a Bayer array disposed in the photosensitive part. The DSP/CPU 3 is a one-chip microcomputer having a variety of digital signal processing functions, including image data compression/expanding processing, furthermore controls each part of the digital camera 1. This DSP/CPU 3 functions as the image number reducing unit, display control unit, extraction unit, and image composition unit of the present invention.

The DSP/CPU 3 is connected to a TG (Timing Generator) 4 that drives the CCD 2 at a frame rate (e.g., 60 fps or 240 fps). The TG 4 is connected to a unit circuit 5 inputting an analog image pickup signal that varies according to an optical image of an object output from the CCD 2. The unit circuit 5 includes a correlated double sampling circuit (CDS circuit) for reducing the drive noise of the CCD 2 that is included in the image pickup signal output from the CCD 2, an automatic gain control circuit (AGC circuit) for adjusting gain on the signal after noise reduction, and an A/D converter for converting the signal after the gain adjustment into a digital signal, the unit circuit 5 converts the analog image pickup signal from the CCD 2 into a digital image signal, and subsequently sends this digitized Bayer data to the DSP/CPU 3.

The DSP/CPU 3 are connected to a display device 6 and a key input part 7, and buffer memory (DRAM) 11, ROM 12, storage memory 13, and an input/output interface 14 are also connected to the DSP/CPU 3 via address/data bus 10. The buffer memory 11 is a buffer for temporarily saving the above-described Bayer data, and in addition serves as the working memory for the DSP/CPU 3.

In other words, the DSP/CPU 3 performs pedestal clamp processing on the Bayer data sent from the unit circuit 5, subsequently converts it into RGB data, and furthermore converts the RGB data into luminance (Y) and chrominance (UV) signals (YUV data). One frame's worth of this YUV data is then stored in the buffer memory 11. When picking up a through-image, one frame's worth of YUV data stored in the buffer memory 11 is sent to the display device 6, wherein it is converted into a video signal and displayed as a through-image.

In addition, when the shutter key operation by the user is detected while in still picture photographing mode, the DSP/CPU 3 executes still picture photographing processing by switching the CCD 2 and unit circuit 5 to a drive system or drive timing for a still picture photographing, being different from those of the through-image. This one frame's worth of YUV data stored in the buffer memory 11 as a result of the still picture photographing processing, by the DSP/CPU 3, is subsequently compressed according to the JPEG or another system, encoded, become a file inside the buffer memory 11, and then recorded to the storage memory 13 (recording unit) via the address/data bus 10 as still picture data (a still picture file).

In addition, in ordinary consecutive photographing (moving picture photographing) mode, when starting instructions for consecutive photographing is detected by a first shutter key operation of the user consecutive photographing, consecutive photographing processing starts, until end instructions for consecutive photographing is detected by a second shutter key operation consecutive photographing, a plurality of frames' worth of YUV data is stored in the buffer memory 11. This plurality of frames' worth of YUV data stored in buffer memory 11 is in series sent to the DSP/CPU 3, compressed according to the JPEG or another system (in the case of moving picture photographing, a predetermined MPEG codec), encoded, and then written as frame data with an given file name to the storage memory 13 via buffer memory 11 and the address/data bus 10. Furthermore, when reviewing still pictures or consecutive photographing (moving pictures), by the DSP/CPU 3, the still picture or consecutive photographing (moving picture) data read from the storage memory 13 is expanded and opened at an image data working area of the buffer memory 11 as still picture data or consecutive photographing (moving picture) frame data. Moreover, in high-speed consecutive photographing (moving picture photographing) mode, when starting instructions for video recording is detected by the shutter key operation, the CCD 2 and the unit circuit 5 start high-speed consecutive photographing processing by switching the through-image photographing (ordinary consecutive photographing) drive timing (60 fps) to a different drive timing (240 fps).

The display device 6 (display unit) includes a color LCD and the driving circuit thereof, in a photographing standby state, the object image imaged by the CCD 2 is displayed as a through-image and during the reproduction of a recorded image, recorded images read and expanded from the storage memory 13. The key input/output part 7 includes a plurality of operation keys, such as a shutter key, a mode settings key, and a power key, and outputs key input signals to the DSP/CPU 3 according to key operation by the user. The shutter key also functions as a consecutive photographing (record) start/stop button during continuous (moving picture) shooting.

In addition, a program chart is stored in the ROM 12, showing combinations of aperture values (F) and shutter speeds corresponding to EVs (Exposure Values) suitable for a variety of photographing modes, e.g., still picture photographing mode, consecutive photographing mode, and through-image photographing mode. The program chart consists of program AE (Auto Exposure) data and an EV value list. Also, the DSP/CPU 3 configures a charge accumulation time based on the shutter speed configured by the program chart. A configured charge accumulation time is supplied as a shutter pulse to the CCD 2 via TG 4. The CCD 2 operates according to this shutter pulse, and as a result, the charge accumulation time, i.e., the exposure time, is controlled. In other words, the CCD 2 functions as an electronic shutter. Furthermore, in the ROM 12 are stored various programs necessary for digital camera functions as well as for the programs shown in the flowcharts to be hereinafter described.

It is possible to connect this digital camera 1 to external devices, such as printers, computers, TV receivers, etc., via the input/output interface 14.

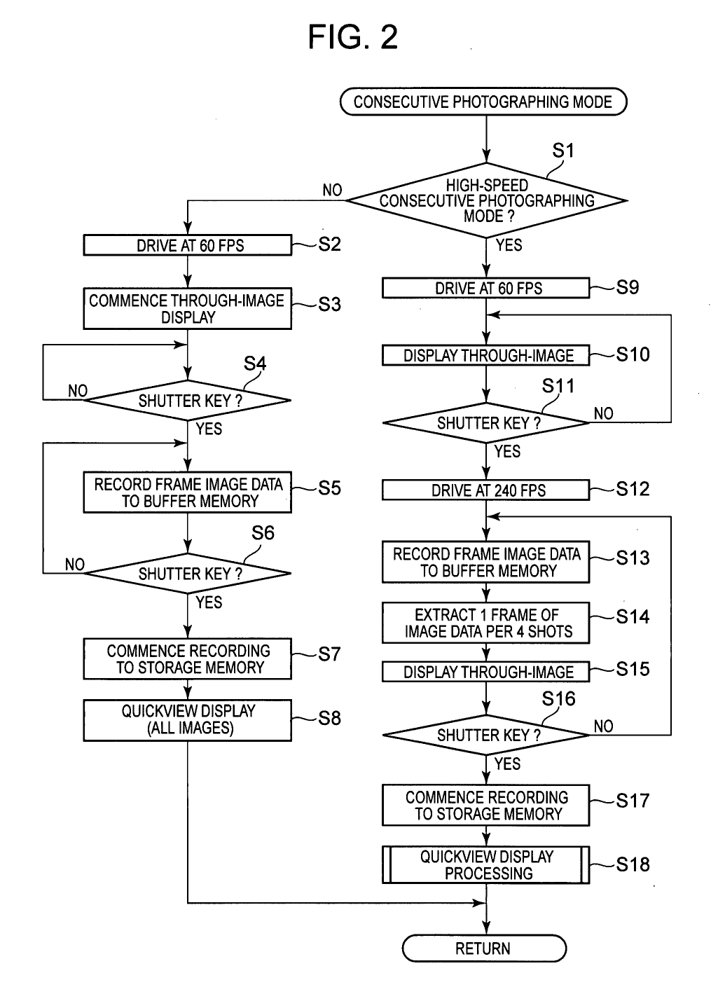

FIG. 2 is a flowchart showing the processing procedures common to all embodiments of the present invention. When the mode settings key provided on the key input part 7, is operated so as to configure for consecutive photographing mode, the DSP/CPU 3, following the program stored in the ROM 12, executes the processing as shown in this flowchart. That is to say, it is first determined whether or not the high-speed consecutive photographing mode of the consecutive photographing mode has been configured by a mode settings key operation of the user (step S1), and in the case where the high-speed consecutive photographing mode is not configured (step S1; NO), the process is shifted to ordinary consecutive photographing mode processing.

In other words, the DSP/CPU 3 controls the TG 4 to drive the CCD 2 at a frame rate of 60 fps (step S2), and based on the frame image data acquired this frame rate, causes the display device 6 to display a through-image (step S3). During this time, the first shutter key operation is monitored (step S4), and if the first shutter key operation is detected, the frame image data acquired the above-described frame rate is successively recorded to the buffer memory 11 (step S5).

Furthermore, until a second shutter key operation is detected (step S6), the processing in steps S5 and S6 are executed, if the second shutter key operation is detected, recording processing starts, wherein the plurality of frame image data accumulated in the buffer memory 11 is given file names and recorded to the storage memory 13 as frame data (step S7). At this time, this data may be collectively recorded as one moving picture file, or separately as one still picture file. After being like this, the quickview display is subsequently executed, wherein all of this recorded frame image data is displayed by the display device 6 (step S8), and then the process returns to step S1.

On the other hand, the result of the determination in step S1, in the case where the high-speed consecutive photographing mode is configured (step S1; YES), the DSP/CPU 3 controls the TG 4 to drive the CCD 2 at a frame rate of 60 fps (step S9), and based on the frame image data acquired this frame rate, causes the display device 6 to display a through-image (step S1). During this time, the first shutter key operation is monitored (step S11), and if the first shutter key operation is detected, the DSP/CPU 3 controls the TG 4 to drive the CCD 2 at a frame rate of 240 fps (step S12). In other words, the frame rate of the CCD 2 is switched from 60 fps to 240 fps. Additionally, while the frame image data acquired this frame rate is successively recorded to the buffer memory 11 (step S13), one frame image data is extracted for every four shots (step S14), and through-image based on these extracted frame image data are displayed by the display device 6 (step S15).

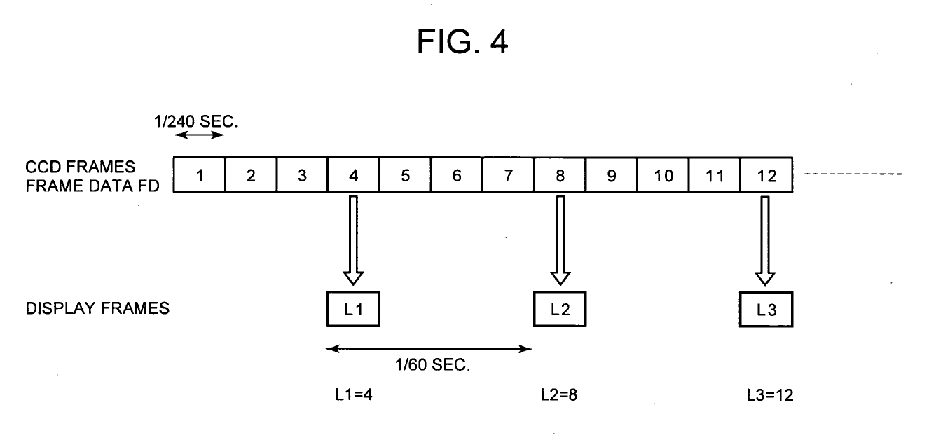

Consequently, as shown in FIG. 4, frame data FD is successively accumulated in the buffer memory 11 at a frame rate of 240 fps, but in the display device 6, wherein it is difficult to display data at this frame rate, through-image (L1, L2, L3 . . . ) are displayed at a display frame rate of 60 fps, that is ¼ of the above frame rate.

Moreover, until a second shutter key operation is detected (step S16), the processing in steps S13-S16 are executed, if a second shutter key operation is detected, recording processing starts, wherein the plurality of frame image data accumulated in the buffer memory 11 is given file names and recorded to the storage memory 13 as frame data (step S17). Similar to the above-described, at this time this data may be collectively recorded as one moving picture file, or separately recorded as one still picture file. After being like this, the quickview display processing is executed (step S18), and the process subsequently returns to step S1.

In the foregoing description of the present embodiment, steps S12-S15 are conducted during the time between the first shutter key operation and the second shutter key operation. However the present embodiment may also be configured such that the above processing steps are conducted while the shutter key is pushed down, or for a predetermined time after the shutter key operation. Additionally, in the foregoing description of the present embodiment, when the high-speed consecutive photographing ends by the second shutter key operation, the quickview display processing (step S18) is automatically executed. However the present embodiment may also be configured such that a determined step is provided whether or not a predetermined key operation has occurred, in the case where this predetermined key operation has occurred, the quickview display processing (step S18) is executed. Furthermore, the present embodiment may also be configured such that a determined step is provided whether or not a predetermined key operation has occurred within a predetermined time, in the case where this predetermined key operation has occurred within the predetermined time.

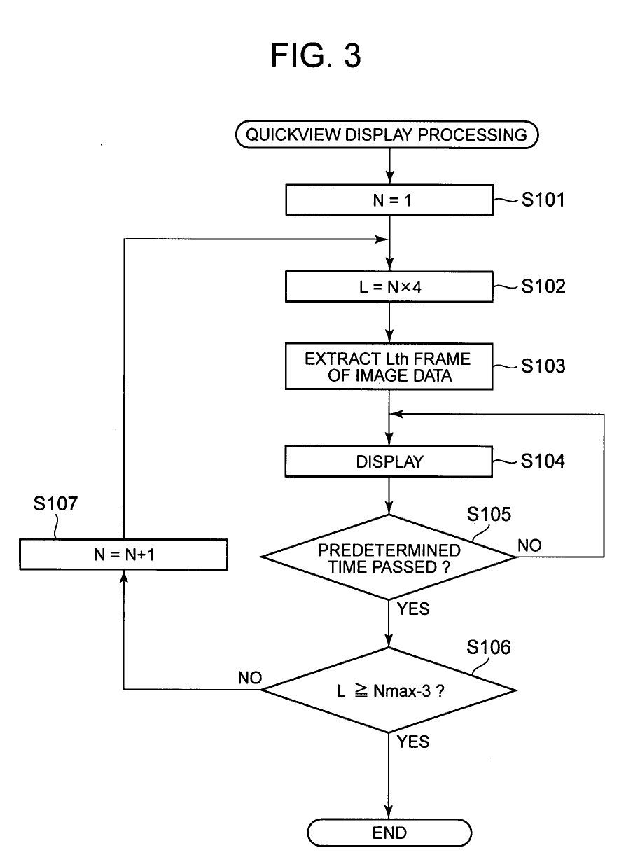

FIG. 3 is a flowchart showing the processing procedure of the quickview processing (step S18) in the first embodiment of the present invention. A counter N in the DSP/CPU 3 is set to an initial value 1 (step S101), and another counter L is set to 4 times of the value of counter N (step S102). Additionally, the Lth frame of image data among the above-described frame data is extracted from the buffer memory 11 (or alternatively the storage memory 13) (step S103), and an image based on this extracted image data is displayed by the display device 6 (step S104). This image display is maintained until a predetermined time (for example, 1 second) has passed (step S105). If the predetermined time has passed (step S105; YES), it is determined whether or not (L≧Nmax−3), in other words, when the processing is conducted to set (L=N×4) in the next step S102, it is determined whether or not L will exceed the total number of image data frames (Nmax) in the above-described frame data (step S106). Additionally, until this determination in step S106 results in a YES, the value of the counter N is incremented (step S107), and the processing in steps S102-S107 are repeated.

Consequently, by executing the processing steps according to this flowchart, the following occurs. As a result of the processing in the first step S102, the value of L becomes (L1=4), as shown in FIG. 4, and as a result of the processing in step S103, the fourth frame image data L1 is read from the frame data FD. As a result of the processing in the second step S102, the value of L becomes (L2=8), and as a result of the processing in step S103, the eighth frame image data L2 is read from the frame data FD. As a result of the processing in the third step S102, the value of L becomes (L3=12), and as a result of the processing in step S103, the twelfth frame image data L3 is read from the frame data FD. In addition, from the subsequent frame data FD, one frame image data is read every four frames, i.e., every fourth image data is read.

Additionally, as a result of the processing in steps S104 and S105, images based on the image data read from every fourth frames are displayed by the display device 6 at a predetermined time interval. Consequently, ¼ of the recorded consecutive photographing images are sampled and displayed by the display device 6, and as a result, the amount of time necessary for quickview display can shorten while still clearly displaying quickview images.

In the foregoing description of the present embodiment, one frame image out of every four is extracted from the frame data, but it should be appreciated that the number of sampled frame images is not limited thereto, and the present embodiment may also be configured such that more or fewer frame images are sampled.

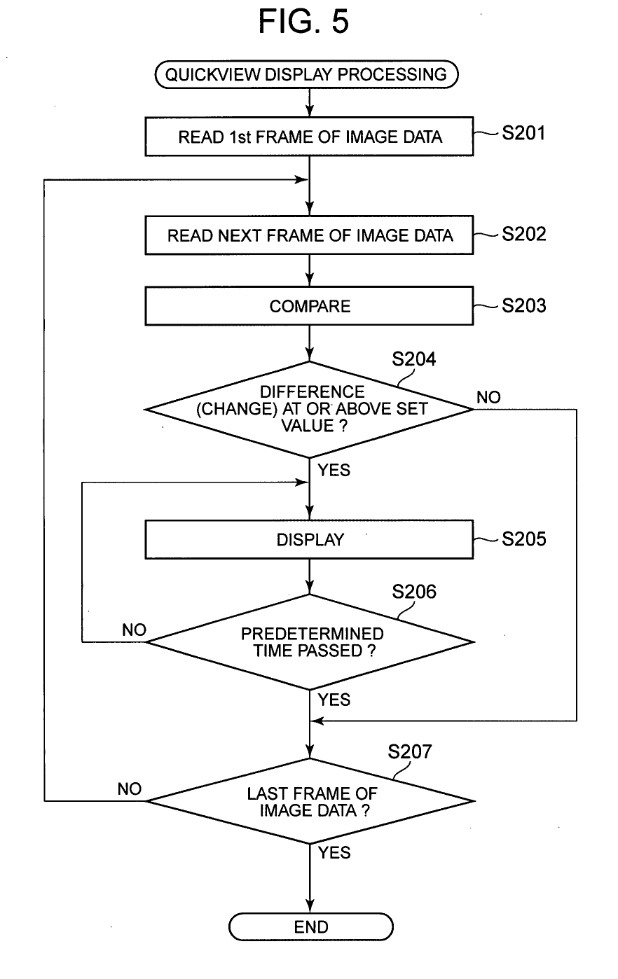

FIG. 5 is a flowchart showing the processing procedure of the quickview display processing (step S18) in the second embodiment of the present invention. A first frame of image data among the above-described frame data is read from the buffer memory 11 (or alternatively the storage memory 13) (step S201), and furthermore, the next (initially, the second) frame of image data is also read (step S202). Subsequently, the images of the image data read in step S201 (or alternatively the image data read in the previous iteration of step S202) and the next image data read in step S202 are compared (step S203), and it is determined whether or not the difference (change) between the two images meets or exceeds a set value (step S204). If the difference between the two images does not meet the set value, i.e., in the case where the change between adjacent images in the consecutive frame data is small (step S204; NO), the process proceeds to step S207 without conducting the processing in steps S205 and S206.

Subsequently, it is determined whether or not the final frame of image data in the plurality of frame data acquired by consecutive photographing has been read in step S202 (step S207), and this process repeats from step S202 until the final frame of image data is read. Consequently, successive frames of image data are iteratively read from the frame data (step S202), and compared to the image read in the previous iteration (step S203). Subsequently, in the case where the result of this comparison is such that the difference (change) between the two images meets or exceeds a set value (step S204; YES), an image based on the image data read in the present iteration is displayed by the display device 6 (step S205). This image display is maintained until a predetermined time (for example, 1 second) has passed (step S206), and once the predetermined time has passed (step S206; YES), the process proceeds to the above-described step S207.

Consequently, by executing the processing steps according to this flowchart, from among the plurality of frame data acquired by consecutive photographing, only the image data corresponding to scenes wherein the object changes greatly or there is intense movement are extracted and displayed as quickview images. As a result, the amount of time necessary for quickview display is shortened while efficiently and clearly displaying quickview images of the movement of the object shot by high-speed consecutive photographing.

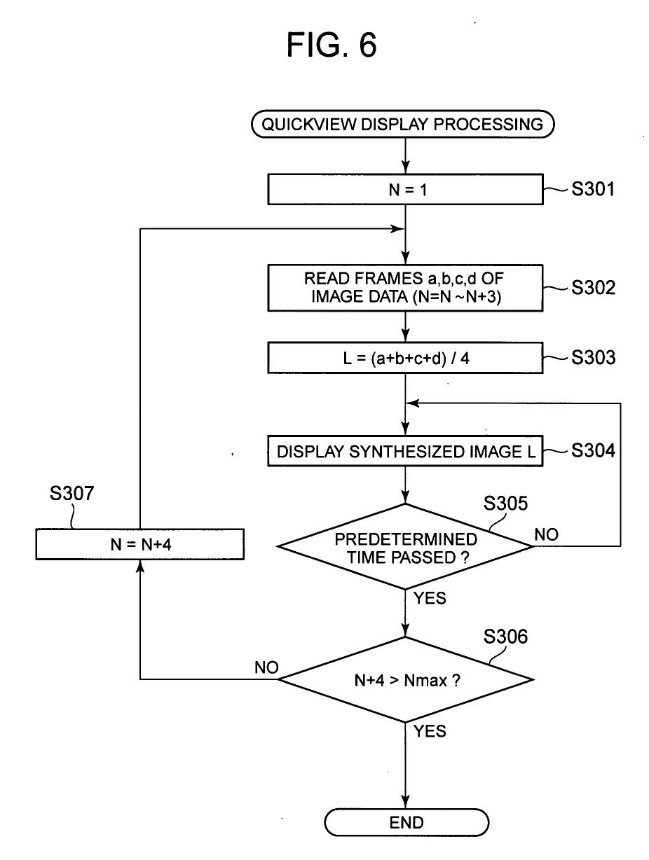

FIG. 6 is a flowchart showing the processing procedure of the quickview display processing (step S18) in the third embodiment of the present invention. A counter N in the DSP/CPU 3 is set to an initial value of 1 (step S301), and frames of image data (a, b, c, d), corresponding to the ordinals (N˜N+3) as indicated by this counter N, are read from the above-described frame data (step S302). Subsequently, by calculating (L=[a+b+c+d]/4), (N˜N+3) frames of image data (i.e., 4 frames) are synthesized at a weight of ¼, thereby creating a single frame of synthesized image data L (step S303). Subsequently, an image based on the synthesized image data L is displayed by the display device 6 (step S304). This image display is maintained until a predetermined time (for example, 1 second) has passed (step S305). If the predetermined time has passed (step S305; YES), it is determined whether or not (N+4>Nmax); in other words, when the processing is conducted to set (N=N+4) in the next iteration of step S307, it is determined whether or not N will exceed the total number of image data frames (Nmax) in the above-described frame data (step S306). Additionally, until this determination in step S306 results in a YES, the value of the counter N is increased by 4 per iteration (step S307), and the processing in steps S302 to S307 are repeated.

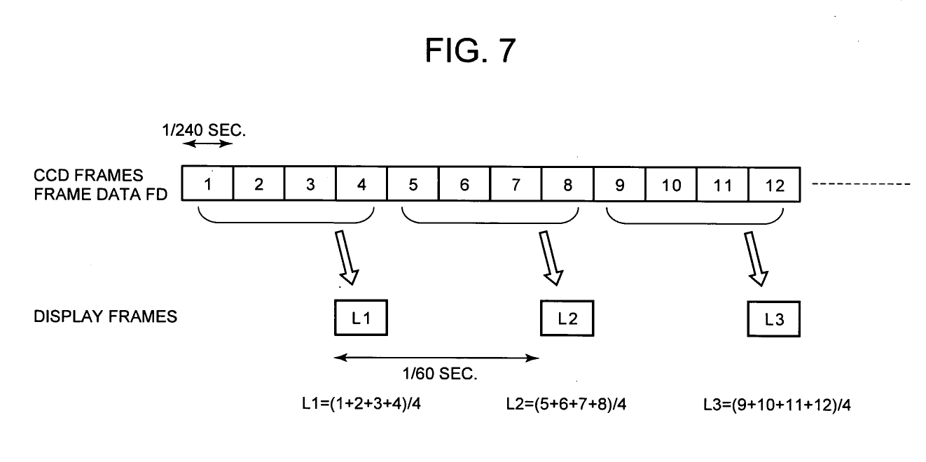

In other words, as a result of the processing in steps S302 to S303, if the current value of N is taken to be N=1, (N=N˜N+3) is equivalent to N=1˜4. Using these values, as shown in FIG. 7, image data frames 1˜4 are read from the frame data FD, and synthesized image data L1 is created using (L1=[1+2+3+4]/4). In addition, in the N=1 state, by executing the processing in step S307 wherein N is set to N=N+4, the value of N becomes N=5, and thus (N=N˜N+3) is equivalent to N=5˜8. Using these values, image data frames 5˜8 are read from the frame data FD, and synthesized image data L2 is created using (L2=[5+6+7+8]/4). Furthermore, in the N=5 state, by executing the processing in step S307 wherein N is set to N=N+4, the value of N becomes N=9, and thus (N=N˜N+3) is equivalent to N=9˜12. Using these values, image data frames 9˜12 are read from the frame data FD, and synthesized image data L3 is created using (L3=[9+10+11+12]/4).

Additionally, as a result of the processing in steps S304 and S305, images, being based on the synthesized image data L synthesized from every four of these image data frames, are displayed by the display device 6 at a predetermined time interval. Consequently, by reducing to ¼ the number of frames of image data acquired by consecutive photographing and displaying these frames by the display device 6, the time required for quickview display is shortened while still clearly displaying quickview images.

In the foregoing description of the first, second, and third embodiments, one frame of image data is extracted every four shots, and through-images based on this extracted frame image data are displayed by the display device 6, as shown in steps S14 and S15 of FIG. 2. However, it should be appreciated that through-images may also be displayed using the processing of the flowchart in FIG. 6. In other words, the above embodiments may also be configured such that, as shown in FIG. 7, synthesized image data L1 is created using (L1=[1+2+3+4]/4), synthesized image data L2 is created using (L2=[5+6+7+8]/4), and synthesized image data L3 is created using (L3=[9+10+11+12]/4) from the CCD frames, and these synthesized image data L1, L2, L3 . . . are displayed as through-images by the display device 6.

In addition, in the foregoing description of the first, second, and third embodiments, a value of 1 second was given as an example of the predetermined time for maintaining the display of each image in the quickview display. However, the predetermined time is not limited to this value, and the predetermined time may be configured to be any suitable value in the range such that the object of the present invention is achieved; namely, in the range such that the quickview display time is shortened, and in addition confirming the contents of the last shot is simplified.

In addition, in the descriptions of each of the foregoing embodiments, images were successively switched at a predetermined time interval, but the present invention may also be configured such that the extracted images are displayed on one screen on a multi-screen display. In this case, the time required for the quickview display is shortened even further. In addition, by reducing the number of images displayed in the multi-screen view to far below that of the number of consecutive photographing frames, each image does not becomes extremely small in the multi-screen view, and therefore each image can be clearly displayed.

In addition, in the case where the number of images to be displayed is large, it is preferable to conduct the multi-screen view display using a plurality of screens, displaying images by switching multi-screen views. In this case, reducing the display frame rate when switching the display of the multi-screen view to lower than that of the above-described high-speed consecutive photographing frame rate makes it easier to confirm the last shot. As a result, even in the case where there are many extracted images, each image can be clearly displayed, and furthermore by using the multi-screen view, the time required for the quickview display can be shortened.

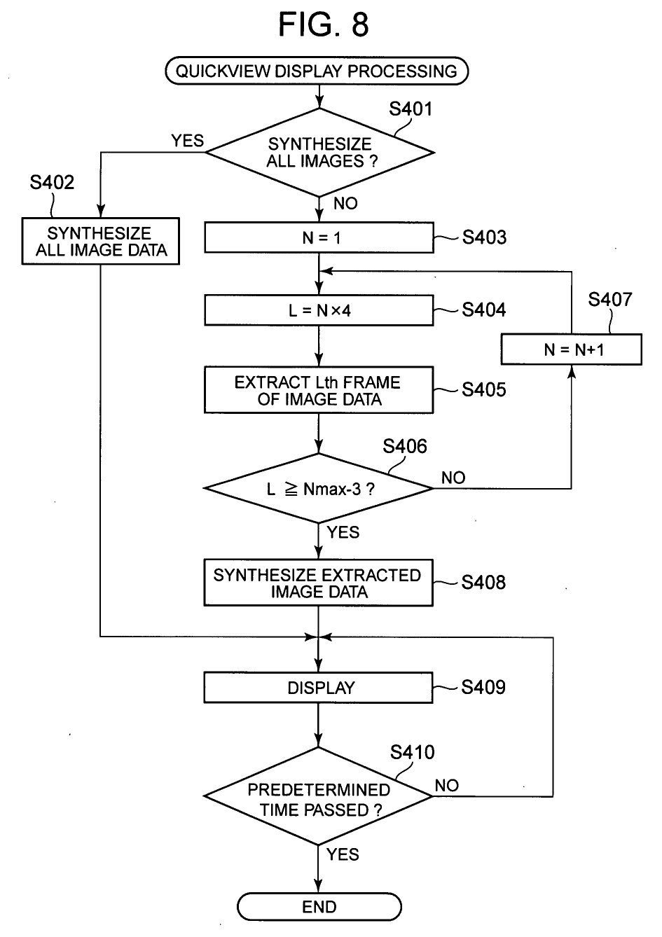

FIG. 8 is a flowchart showing the processing procedure of the quickview display processing (step S18) in the fourth embodiment of the present invention. First, it is determined whether or not a “synthesize all images” option has been selected in advance by a user key operation (step S401). In the case where the “synthesize all images” option has been selected (step S401; YES), all of the images constituting the above-described frame data are multiply synthesized, thereby creating a single frame of synthesized image data L0 (step S402).

In addition, in the case where the “synthesize all images” option has not been selected (step S401; NO), a counter N in the DSP/CPU 3 is set to an initial value of 1 (step S403), and another counter L is set to 4 times the counter N (step S404). Additionally, the Lth frame of image data among the above-described frame data is extracted from the buffer memory 11 (or alternatively the storage memory 13) and stored in the buffer memory 11 (step S405). Subsequently, it is determined whether or not (L=Nmax−3); in other words, when the processing is conducted to set (L=N×4) in step next S404, it is determined whether or not L will exceed the total number of image data frames (Nmax) in the above-described frame data (step S406). Additionally, until this determination in step S406 results in a YES, the value of the counter N is incremented (step S407), and the processing in steps S404-S407 are repeated.

Consequently, by executing the processing steps according to this flowchart, the following occurs, in a manner equivalent to that of the above-described first embodiment. As a result of the processing in the first iteration of step S404, the value of L becomes (L1=4), as shown in FIG. 4, and as a result of the processing in step S405, the fourth frame of image data L1 is extracted from the frame data. As a result of the processing in the second iteration of step S404, the value of L becomes (L2=8), and as a result of the processing in step S405, the eighth frame of image data L2 is extracted from the frame data. As a result of the processing in the third iteration of step S404, the value of L becomes (L3=12), and as a result of the processing in step S405, the twelfth frame of image data L3 is read from the frame data. In addition, from the subsequent frame data, one frame of image data out of every four frames is read.

Additionally, when the determination of step S406 results in a YES, the plurality of frames of image data extracted in the above-described iterations of step S405 are multiply synthesized to create a single frame of synthesized image data LP (step S408). Subsequently, an image based on either the synthesized image data LO multiply synthesized in the above-described step S402, or alternatively the synthesized image data LP multiply synthesized in the above-described step S408, is displayed by the display device 6 (step S409). This image display is maintained until a predetermined time has passed (step S410), and if the predetermined time has passed (step S410; YES), the image display (i.e., the quickview display) ends.

Consequently, in the present embodiment, since a single image is displayed in the quickview display, the time required for quickview display is shortened. In addition, since the displayed image is either an image multiply synthesized from all the images constituting the above-described frame data, or alternatively an image multiply synthesized from a plurality of images intermittently extracted at a set interval, a synthesized image reflecting the movement of the object is created. As a result, an effective image display can be conducted as the quickview display following high-speed consecutive photographing.

In the foregoing description of the present embodiment, a plurality of images intermittently extracted at a predetermined interval were multiply synthesized. However, it should be appreciated that, as shown in the second embodiment, images showing change in the object may also be extracted and multiply synthesized. As a result, a synthesized image reflecting the particular movement of the object is created, and therefore a more effective image display can be conducted as the quickview display following high-speed consecutive photographing. In addition, in the description of the foregoing embodiments, the phrases “consecutive photographing” and “high-speed consecutive photographing” were solely used. However, these phrases are synonymous with “moving picture photographing” and “high-speed moving picture photographing”, and therefore “moving picture photographing” and “high-speed moving picture photographing” may be respectively substituted in the foregoing description.

Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments.

Various modifications made within the meaning of an equivalent of the claims of the invention and within the claims are to be regarded to be in the scope of the present invention.

This application is based on Japanese Patent Application No. 2006-253633 filed on Sep. 20, 2006 and including specification, claims, drawings and summary. The disclosure of the above Japanese Patent Application is incorporated herein by reference in its entirety.

What is claimed is:

1. An image pickup device comprising:
a display unit;
an acquisition unit for acquiring a consecutive plurality of object images by consecutively picking up an object according to a predetermined frame rate in response to photographic operations;
a recording unit for recording the plurality of object images acquired by the acquisition unit;
an image number reducing unit for reducing the number of the plurality of object images acquired by the acquisition unit; and
a display control unit for causing the display unit to display object images of the number reduced in the image number reducing unit immediately after the plurality of object images are acquired by the acquisition unit.

2. The image pickup device according to claim 1,
wherein the image number reducing unit comprises an extraction unit for extracting predetermined images from the plurality of object images acquired by the acquisition unit; and
the display control unit causes the display unit to display the object images extracted by the extraction unit.

3. The image pickup device according to claim 2,
wherein the extraction unit extracts images every predetermined frame number from the plurality of object images acquired by the acquisition unit.

4. The image pickup device according to claim 2,
wherein the extraction unit extracts images exhibiting large movement in the object from the plurality of object images acquired by the acquisition unit.

5. The image pickup device according to claim 1,
wherein the image number reducing unit comprises an image synthesizing unit for creating a plurality of synthesized images by synthesizing a predetermined number of consecutive images from the plurality of object images acquired by the acquisition unit; and
the display control unit causes the display unit to display the plurality of synthesized images created by the image synthesizing unit.

6. The image pickup device according to claim 1,
wherein the display control unit causes the display unit to successively display each of the object images by switching at a predetermined time interval.

7. The image pickup device according to claim 1,
wherein the display control unit causes the display unit to display each of the object images on a multi-screen display.

8. The image pickup device according to claim 1,
wherein the image number reducing unit comprises an image synthesizing unit for creating a single image by synthesizing all of the object images acquired by the acquisition unit; and
the display control unit causes the display unit to display the single image synthesized by the image synthesizing unit.

9. The image pickup device according to claim 1,
wherein the image number reducing unit comprises an image synthesizing unit for creating a single image by synthesizing extracted images which are an extracted portion of the plurality of object images acquired by the acquisition unit; and
the display control unit causes the display unit to display the single image synthesized by the image synthesizing unit.

10. The image pickup device according to claim 1,
wherein the display control unit comprises a unit for causing the display unit to display object images of the number reduced in the image number reducing unit, as through images, during the acquisition of the plurality of object images by the acquisition unit.

11. The image pickup device according to claim 1, furthermore comprising:
a selection unit for selecting either a high-speed consecutive photographing mode or an ordinary consecutive photographing mode;
wherein the image number reducing unit conducts processing to reduce the number of the plurality of object images in the case where the high-speed consecutive photographing mode is selected by the selection unit; and
the display control unit causes the display unit to display all of the object images acquired by the acquisition unit in the case where the ordinary consecutive photographing mode is selected by the selection unit.

12. The image pickup device according to claim 1,
wherein the display control unit commences display of the object images in response the ending of the acquisition of the plurality of object images by the acquisition unit.

13. The image pickup device according to claim 1,
wherein the display control unit commences display of the object images in response to a predetermined key operation after the acquisition of the plurality of object images by the acquisition unit.

14. An image display control method, comprising:
an acquisition step for acquiring a consecutive plurality of object images by consecutively picking up an object according to a predetermined frame rate in response to photographic operations;
a recording step for recording the plurality of object images acquired in the acquisition step;
an image number reducing step for reducing the number of the object images acquired in the acquisition step; and
a display control step for causing a display unit to display object images of the umber reduced in the image number reducing step, immediately after the plurality of object images is acquired in the acquisition step.

15. An image display control program (recorded on a recording medium) causing a computer to perform certain functions, the computer included in an image pickup device comprising:
a display unit;
an acquisition unit for acquiring a consecutive plurality of object images by consecutively picking up an object according to a predetermined frame rate in response to photographic operations; and
a recording unit for recording the plurality of object images acquired by the acquisition unit;
wherein the program causes the computer to function as:
an image number reducing unit for reducing the number of object images acquired by the acquisition unit; and
a display control unit for causing the display unit to display object images of the number reduced in the image number reducing unit, immediately after the plurality of object images is acquired by the acquisition unit.
